(19) United States
(12) Patent Application Publication
(10) Pub. No.: US 2007/0064448 A1
(43) Pub. Date: Mar. 22, 2007

(54) Backlight module having tray integrally formed with frame, and liquid crystal display having same

(75) Inventors: Ming-Chiang Yu, Miao-Li (TW); Yu-Chih Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/515,577

(22) Filed: Sep. 5, 2006

(30) Foreign Application Priority Data
Sep. 5, 2005 (TW) 94130314

(51) Int. Cl. F21V 7/04

(52) U.S. Cl. 362/633; 362/612; 362/613; 362/632

(57) ABSTRACT

An exemplary backlight module (12) includes a light guide plate (14), and a frame assembly (16). The frame assembly includes a first frame (18) and a second frame (19) integrally formed with the first frame. The first frame accommodates the light guide plate, and has a flared protrusion (184). The second frame defines a flared hole (197) therein. The protrusion of the first frame is locked in the hole.

### FIELD OF THE INVENTION

The present invention relates to backlight modules such as those used in liquid crystal displays (LCDs), and more particularly to a backlight module that has a tray integrally formed with a frame.

### GENERAL BACKGROUND

Liquid crystal displays are commonly used as display devices for compact electronic apparatuses, because they not only provide good quality images but are also very thin. As liquid crystal molecules in a liquid crystal display do not emit any light themselves, the liquid crystal molecules have to be lit by a light source so as to clearly and sharply display text and images. Therefore, liquid crystal displays usually require a backlight module.

Referring to FIG. 6, a typical backlight module 60 includes a light guide plate 62, a plastic frame 64, and a tray 66, disposed in that order from top to bottom. The backlight module 60 further includes four light emitting diodes (LEDs) 68 disposed adjacent to a light incident surface 622 of the light guide plate 62. The plastic frame 64 has two opposite long walls 642, and a pair of protrusions 644 integrally protruding outward from an outmost vertical face (not labeled) of each long wall 642. Each protrusion 644 has an isosceles trapezoid profile. The tray 66 includes two pairs of rectangular notches 662 respectively corresponding to the protrusions 644.

In assembly of the backlight module 60, the light guide plate 62 and the light emitting diodes 68 are received in the plastic frame 64, and the resulting subassembly is then received in the tray 66. The protrusions 644 of the plastic frame 64 are engaged in the notches 662 of the tray 66, whereby the plastic frame 64 and the tray 66 are locked together. However, the step of attaching the plastic frame 64 to the tray 66 is needed, which adds to the cost of manufacturing the backlight module 60. In addition, assembly tolerances apply as between the protrusions 644 and the notches 662, and these tolerances are liable to be exceeded on occasion. Moreover, the protrusions 644 are liable to be scraped when they are pressed into the respective notches 662. When this happens, loose plastic particles produced are liable to either deposit on optical surfaces of the light guide plate 62 or be dispersed in a clean room in which the backlight module 60 is assembled. That is, the light guide plate 62 or the clean room becomes contaminated.

What is needed, therefore, is a backlight module that can overcome the above-described deficiencies. What is also needed is a liquid crystal display employing such a backlight module.

### SUMMARY

In a preferred embodiment, a backlight module includes a light guide plate, and a frame assembly. The frame assembly includes a first frame and a second frame integrally formed with the first frame. The first frame accommodates the light guide plate, and has a flared protrusion. The second frame defines a flared hole therein. The protrusion of the first frame is locked in the hole.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present backlight module and liquid crystal display. In the drawings, like reference numerals designate corresponding parts throughout various views, and all the views are schematic.

FIG. 1 is an exploded, isometric view of a liquid crystal display according to a first embodiment of the present invention, the liquid crystal display including a backlight module, the backlight module including a frame assembly.

FIG. 2 is a cross-sectional view taken along line II-II of FIG. 1.

FIG. 3 is an isometric view of a tray of the frame assembly of FIG. 1, in isolation.

FIG. 4 is similar to FIG. 2, but showing a corresponding view in the case of a liquid crystal display according to a second embodiment of the present invention.

FIG. 5 is similar to FIGS. 2 and 4, but showing a corresponding view in the case of a liquid crystal display according to a third embodiment of the present invention.

FIG. 6 is an exploded, isometric view of a conventional backlight module.

### DETAILED DESCRIPTION OF PREFERRED EMBODIMENTS

Reference will now be made to the drawings to describe the preferred embodiments in detail.

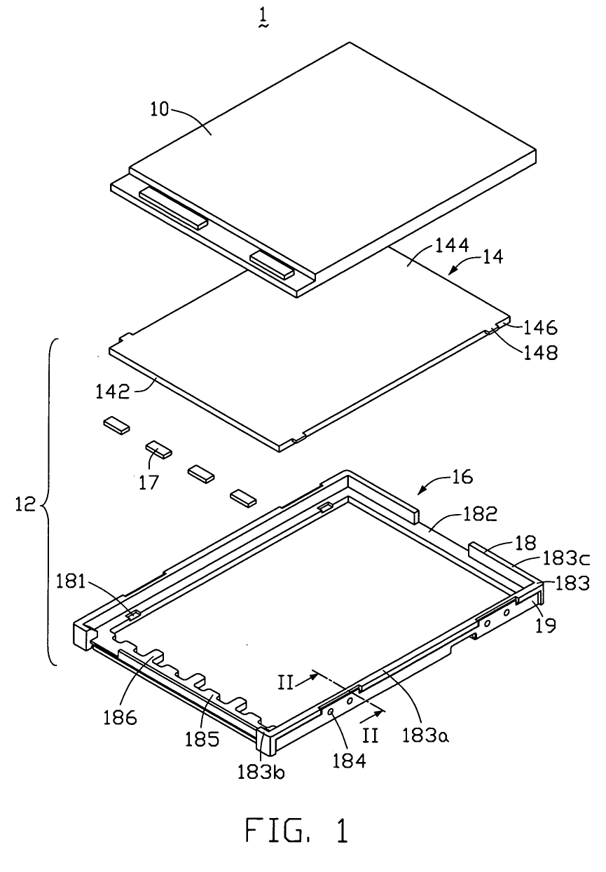

FIG. 1 is an exploded, isometric view of a liquid crystal display according to a first embodiment of the present invention. The liquid crystal display 1 includes a liquid crystal panel 10, and a backlight module 12 located adjacent to the liquid crystal panel 10. The backlight module 12 includes a light guide plate 14 and a frame assembly 16. The backlight module 12 further includes a plurality of light emitting diodes 17 located adjacent to a light incident surface 142 of the light guide plate 14. The light emitting diodes 17 cooperatively serve as a light source. The frame assembly 16 includes a frame 18, and a tray 19 integrally formed with the frame 18. The light guide plate 14 and the light emitting diodes 17 are received and held in the frame assembly 16.

The light guide plate 14 includes the light incident surface 142, a light emitting surface 144 perpendicularly connecting with the light incident surface 142, and two opposite side surfaces 146 adjacent to both the light incident surface 142 and the light emitting surface 144. Each side surface 146 has a pair of ears 148 integrally extending outward therefrom. The ears 148 are arranged near two ends of the side surface 146 respectively, and a top surface (not labeled) of each ear 148 is coplanar with the light emitting surface 144. The light guide plate 14 can for example be made from polycarbonate (PC) or polymethyl methacrylate (PMMA), and can for example be manufactured by an injection molding method.

The frame 18 includes a spacing board 182, and two symmetrically opposite first side walls 183 integrally extending from the spacing board 182. The spacing board 182 is generally frame-shaped, and protrudes perpendicularly inward from inner surfaces (not labeled) of the first side walls 183. Thus the spacing board 182 defines a rectangular space (not labeled) for accommodating the light guide plate 14. Outmost vertical faces of the spacing board 182 are either coplanar with or recessed relative to corresponding outmost vertical faces of the first side walls 183. A plurality of first protrusions 185 and a plurality of partition second protrusions 186 are formed at an inner surface of one end of the spacing board 182. The first protrusions 185 and the second protrusions 186 are disposed parallel to each other, are alternately arranged along a length of said end of the spacing board 182, and extend into the space. The second protrusions 186 are longer than the first protrusions 185. The light emitting diodes 17 can be respectively disposed in a series of spaces defined between every two adjacent second protrusions 186. That is, the light emitting diodes 17 can be arranged to abut the first protrusions 185 respectively. The spacing board 182 also defines two pairs of notches 181 positioned at two opposite inner long sides (not labeled) thereof respectively. Each notch 181 is located to correspond to a respective one of the ears 148 of the light guide plate 14. That is, the ears 148 can be received in the notches 181 respectively. The frame 18 is preferably made from white polycarbonate, plastic, or any other suitable material.

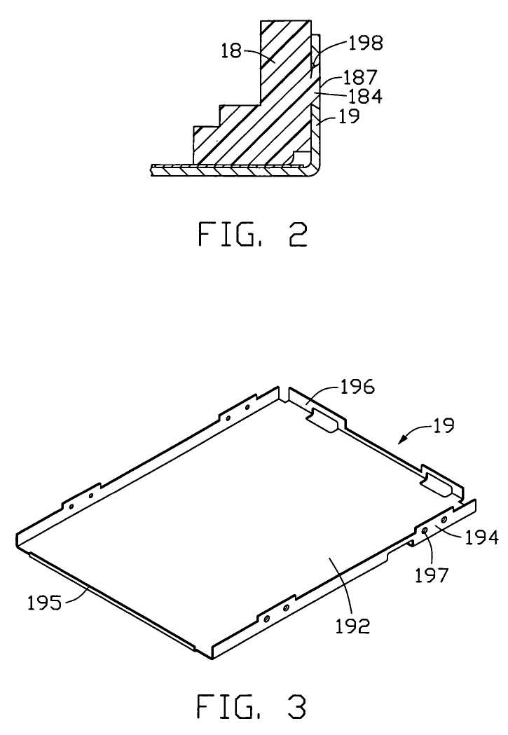

Each first side wall 183 has a generally asymmetrical U-shape, and includes a first arm 183a, a second arm 183b, and a third arm 183c. Each first arm 183a extends along a corresponding long side of the frame 18. The corresponding second arm 183b and the corresponding third arm 183c respectively extend perpendicularly inward in a same direction from two opposite ends (not labeled) of the first arm 183a. The third arm 183c is longer than the second arm 183b. The second arms 183b of the opposite first side walls 183 are generally adjacent to each other. Referring also to FIG. 2, each first arm 183a includes two pairs of third protrusions 184 integrally extending outward from a recessed outer vertical face thereof. Each of the third protrusions 184 has a generally frusto-conical shape, which flares out in a direction away from the recessed outer vertical face. Each third protrusion 184 defines an inmost extremity (not labeled) at the recessed outer vertical face, and an outmost extremity 187 opposite to the inmost extremity. The inmost extremity and the outmost extremity 187 are circular, and are parallel to each other. A diameter of the outmost extremity 187 is larger than that of the inmost extremity.

Referring to FIG. 3, the tray 19 includes a bottom plate 192, two opposite second side walls 194, a low-profile third side wall 195, and a fourth side wall 196. The second side walls 194, the third side wall 195, and the fourth side wall 196 integrally extend from the bottom plate 192. The third side wall 195 and the fourth side wall 196 are opposite and parallel to each other, and are perpendicular to the second side walls 194. Each of the second side walls 194 defines two pairs of through holes 197 therein. Each through hole 197 has a generally frusto-conical shape, which flares out in a direction away from a center axis of the tray 19. Each through hole 197 defines a circular first hatch 198 at an inmost face of the second side wall 194, and a circular second hatch (not labeled) at an outmost face of the second side wall 194. A diameter of the first hatch 198 is less than that of the second hatch. The tray 19 is preferably made from metal, such as iron, aluminum, magnesium, or any suitable alloy thereof.

The tray 19 is integrally formed with the frame 18 to provide the frame assembly 16. The frame assembly 16 can be manufactured by an injection molding method. The bottom plate 192 of the tray 19 is located adjacent to the space defined by the spacing board 182. Each second side wall 194 of the tray 19 is located adjacent to the first arm 183a of the corresponding first side wall 183. The third side wall 195 of the tray 19 is located adjacent to the second arms 183b. The fourth side wall 196 of the tray 19 is located adjacent to the third arms 183c. Each third protrusion 184 of the frame 18 is formed in a corresponding through hole 197 of the tray 19. The outmost extremity 187 of each third protrusion 184 is flush with the outmost face of the corresponding second side wall 194. Because of the corresponding flared configurations of the third protrusions 184 and the through holes 197, the third protrusions 184 are firmly locked in the through holes 197, and the frame 18 and the tray 19 are integrally bound together as the unitary frame assembly 16.

Unlike in the prior art, because the frame assembly 16 comprises the tray 19 integrally formed with the frame 18, there is no need for a process of attaching a separate frame and a separate tray together. This makes assembly of the backlight module 12 efficient. Moreover, each third protrusion 184 is integrally formed in a corresponding through hole 197, instead of having each of protrusions pressed into a corresponding hole as in the prior art. Thus there is little or no risk of particles being scraped off from the third protrusions 184. Accordingly, the backlight module 12 is protected from contamination, and the optical performance of the backlight module 12 is unimpaired.

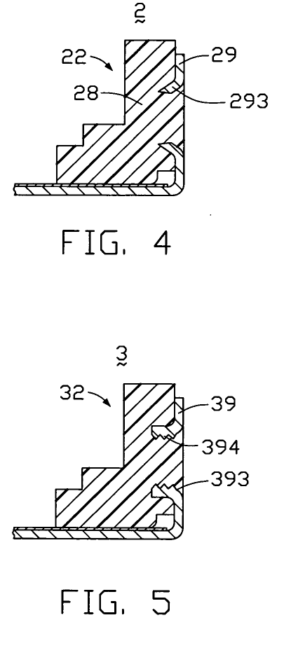

Referring to FIG. 4, a liquid crystal display 2 according to a second embodiment of the present invention is similar to the liquid crystal display 1. However, the liquid crystal display 2 includes a frame 28 and a tray 29. The frame 28 includes a plurality of third protrusions (only one shown, not labeled), and the tray 29 includes a plurality of corresponding collars 293 (only one shown). Each collar 293 is an integral portion of a corresponding second side wall (not labeled) of the tray 29, and protrudes inwardly from a main body of the second side wall. The collar 293 enables the third protrusion to have a larger size. This facilitates the third protrusion being firmly locked in the collar 393, and also provides the interlocked third protrusion and collar 393 with greater mechanical strength and reliability. Thereby, the integrally bound frame 28 and tray 29 provides a very stable unitary frame assembly for the liquid crystal display 2.

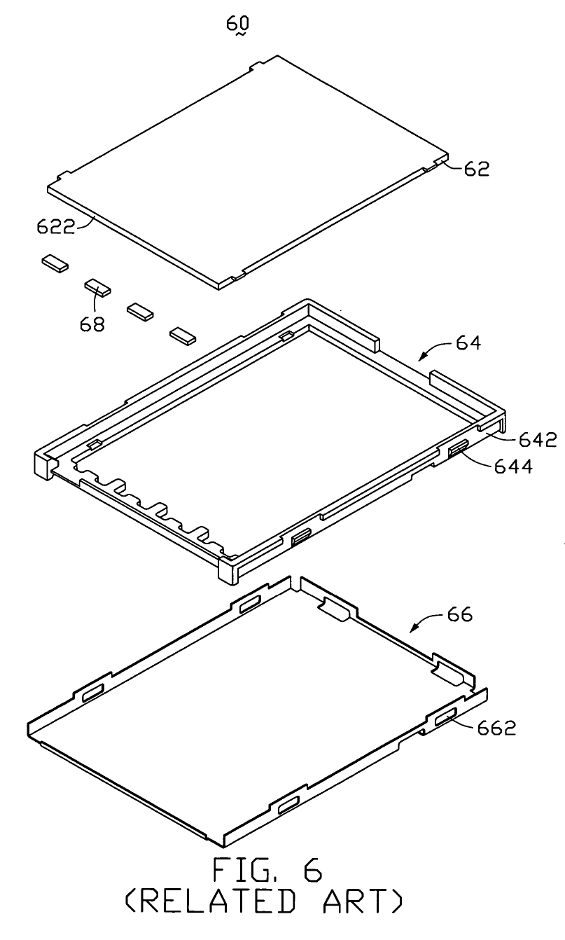

Referring to FIG. 5, a liquid crystal display 3 according to a third embodiment of the present invention is similar to the liquid crystal display 2. However, the liquid crystal display 3 includes a frame (not labeled) and a tray 39. The frame includes a plurality of third protrusions (only one shown, not labeled), and the tray 39 includes a plurality of corresponding collars 393 (only one shown). Each collar 393 is an integral portion of a corresponding second side wall (not labeled) of the tray 39, and protrudes inwardly from a main body of the second side wall. The collar 393 includes a plurality of saw-tooth structures 394 formed at an inner surface (not labeled) thereof. The saw-tooth structures 394 help ensure that the third protrusion 184 is firmly locked in the collar 393. Thereby, the integrally bound frame and tray 39 provides a very stable unitary frame assembly for the liquid crystal display 3.

Further or alternative embodiments may include the following. The frame 18 and the tray 19 can be integrally formed by a hot pressing method, a fusion method, or a molding method. Each third protrusion 184 can have an isosceles trapezoidal configuration, a hexagonal flared configuration, a pentagonal flared configuration, or another suitable generally flared configuration.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate; and
a frame assembly comprising:
a first frame accommodating the light guide plate and having a flared protrusion; and
a second frame integrally formed with the first frame, the second frame defining a flared hole therein, the protrusion of the first frame being locked in the hole.

2. The backlight module in claim 1, wherein the hole defines an inmost hatch nearest to the light guide plate.

3. The backlight module in claim 2, wherein a diameter of the inmost hatch is less than that of an outmost extremity of the protrusion.

4. The backlight module in claim 1, wherein the protrusion has a generally frusto-conical shape.

5. The backlight module in claim 1, wherein the second frame further comprises a portion protruding inward into the first frame, said portion surrounding the hole and locking the protrusion therein.

6. The backlight module in claim 5, wherein said portion is a collar.

7. The backlight module in claim 5, wherein the second frame further comprises a plurality of saw-tooth structures formed at an inner surface of said portion at the hole, the saw-tooth structures facilitating the locking of the protrusion.

8. The backlight module in claim 1, wherein the frame assembly is formed as the result of an injection molding method, a hot pressing method, or a fusion method.

9. The backlight module in claim 1, wherein the first frame is made from polycarbonate, plastic, or any other polymer.

10. The backlight module in claim 1, wherein the second frame is made from iron, aluminum, magnesium, or any alloy thereof.

11. A liquid crystal display comprising:
a liquid crystal panel; and
a backlight module adjacent to the liquid crystal panel, the backlight module comprising:
a light guide plate; and
a frame assembly comprising:
a first frame accommodating the light guide plate and having a flared protrusion; and
a second frame integrally formed with the first frame, the second frame defining a flared hole therein, the protrusion of the first frame being locked in the hole.

12. The liquid crystal display in claim 11, wherein the hole defines an inmost hatch nearest to the light guide plate.

13. The liquid crystal display in claim 12, wherein a diameter of the inmost hatch is less than that of an outmost extremity of the protrusion.

14. The liquid crystal display in claim 11, wherein the protrusion has a generally frusto-conical shape.

15. The liquid crystal display in claim 11, wherein the second frame further comprises a portion protruding inward into the first frame, said portion surrounding the hole and locking the protrusion therein.

16. The liquid crystal display in claim 15, wherein said portion is a collar.

17. The liquid crystal display in claim 15, wherein the second frame further comprises a plurality of saw-tooth structures formed at an inner surface of said portion at the hole, the saw-tooth structures facilitating the locking of the protrusion.

18. A backlight module comprising:
a light guide plate; and
a frame assembly comprising:
an insulative frame accommodating the light guide plate; and
a metallic frame integrally formed with the first frame under a tenon-mortise manner.
